(19) United States
(12) Patent Application Publication
(10) Pub. No.: US 2003/0039259 A1
(43) Pub. Date: Feb. 27, 2003

(54) Traffic flow template for managing packet data flows

(76) Inventor: Lila Madour, Kirkland (CA)

Correspondence Address: SANDRA BEAUCHESNE, Ericsson Canada Inc., Patent Department (LMC/IP), 8400 Decarie Blvd., Town Mount Royal, QC, H4P 2N2, CA

(21) Appl. No.: 10/190,817

(22) Filed: Jul. 9, 2002

Related U.S. Application Data
(60) Provisional application No. 60/303,801, filed on Jul. 10, 2001.
(60) Provisional application No. 60/307,184, filed on Jul. 24, 2001.

(51) Int. Cl. H04L 12/28

(52) U.S. Cl. 370/401; 370/349

(57) ABSTRACT

The present invention relates to a traffic flow template for indicating preferred treatment of a service instance. For doing so, the table provides at least one packet filter, and an IP address associated with the packet filter. Each of the at least one packet filter includes packet filter attributes and an associated packet filter identifier. A terminal manages the packet filters. The terminal manages packet filter identifiers, manages evaluation precedence indexes of the packet filters, creates a packet filter content, and associates the packet filter to a current IP address of the terminal. The traffic flow template is stored at a packet data serving node (PDSN). The PDSN receives a pattern update request message from a terminal, and uses an evaluation precedence index to look up for a packet filter match the pattern update request message.

### PRIORITY STATEMENT UNDER 35 U.S.C S.119 (e) & 37 C.F.R. S.1.78

This non-provisional patent application claims priority based upon the prior U.S provisional patent applications entitled “PROPOSED TEXT TO ANNEX YYY DESCRIBING MCFTP Rev 0.1”, application No. 60/307,184, filed Jul. 24, 2001, in the name of Lila Madour, and “PROPOSED TEXT TO PS0001B ON TRAFFIC FLOW TEMPLATE IN THE QoS SECTION”, application No. 60/303,801, filed Jul. 10,2001, in the name of Lila Madour.

### BACKGROUND OF THE INVENTION

1Field of the Invention

The present invention relates to a traffic flow template for managing packet data flows in a telecommunications network.

2. Description of the Prior Art

Nowadays, in CDMA2000 wireless IP networks, whenever a terminal needs to communicate with the wireless IP network, a PPP session is established between the terminal and a Packet Data Serving Node (PDSN) of the wireless IP network. In a CDMA2000 packet core network (PCN), the PDSN is responsible for supporting authentication mechanisms and a configuration option to allow a terminal to receive IP services such as VoIP (Voice over IP). The terminal and the PDSN are both ultimately connected to a Radio Access Network (RAN), which maintains a Point-to-Point Protocol (PPP) session between the PDSN and the terminal.

The PPP session consists of a data link protocol between the terminal and the PDSN. The PPP session defines a period during which a particular PPP connection instance is maintained in the open state in both the terminal and PDSN. The PPP session is also maintained during period when the PPP connection is dormant. A dormant PPP connection is one in which a packet-data session has been established, but no data has been exchanged for a long period of time. For example, a terminal may download information from the PDSN, and then spend a considerable amount of time reading it. Under these circumstances, when an inactivity timer expires, the MSC deallocates the radio traffic channel. The PPP session, however, is maintained. If the user then requests or sends additional data, the dormant PPP connection is reactivated by reallocating a traffic channel so that the data can be transferred. Furthermore, if the terminal hands off from one radio access network (RAN) to another RAN but is still connected to the same PDSN, the PPP connection remains. If a terminal changes PDSN, a new PPP connection is created with the new PDSN. In addition, during a PPP session one or many IP addresses can be assign to a terminal.

CDMA2000 wireless IP network is defined as being a packet data network in which IP applications and services can be provided. For doing so, applications and services running over the CDMA2000 wireless IP network are characterized by traffic classes, such as: Background, Interactive, Streaming, and Conversational. The Background class is used for delay-intensive applications such as FTP and other types of bulk downloads. The Interactive traffic class is used for applications for which a user enters a request and must wait for a response. An application in the Interactive traffic classes is not strictly real-time and may include web browsing, instant messaging, telnet, SSH or news. The Streaming class is used for applications that are not sensitive to round-trip latency, but must preserve strict inter-packet and intra-flow timing characteristics. An example of an application of a Streaming class may be streaming audio or video. The Conversational class is defined as a class that is used for applications that are sensitive to round-trip latency and must preserve strict inter-packet and intra-flow timing characteristics. An example of an application of a Conversational class may be streaming voice or video conferencing.

However, there is a need for efficiently supporting one or more classes of applications and services in a way to be transported simultaneously during a same PPP session. More specifically, there is a need to efficiently manage packet data flows related to different traffic classes, applications and services. The invention provides a solution to this problem.

### SUMMARY OF THE INVENTION

It is therefore one broad object of this invention to provide a traffic flow template for indicating preferred treatment of a service instance, the table comprising:

at least one packet filter, each of the at least one packet filter including packet filter attributes and an associated packet filter identifier; and

an IP address associated with the packet filter.

It is also another object of the present invention to provide a terminal for managing packet filters, the terminal being capable of:

managing packet filter identifiers;

managing evaluation precedence indexes of the packet filters;

creating a packet filter content, the packet filter content including packet filter attributes and an associated packet filter identifier; and

associating packet filter to a current IP address of the terminal.

It is a further object of the present invention to provide a packet data serving node (PDSN) for storing at least one traffic flow template associated to a service instance, the PDSN being capable of:

receiving a pattern update request message from a terminal, the pattern update request message including at least a packet filter identifier; and

using an evaluation precedence index to look up for a packet filter match.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is illustrating a PPP session in a telecommunications network between a terminal and a packet data serving node in accordance with the present invention;

FIG. 2 is illustrating a traffic flow template in accordance with the present invention; and

FIG. 3 is illustrating a message flow diagram for managing service instances in a telecommunications network.

### DETAILED DESCRIPTION OF THE PREFERRED EMBODIMENTS

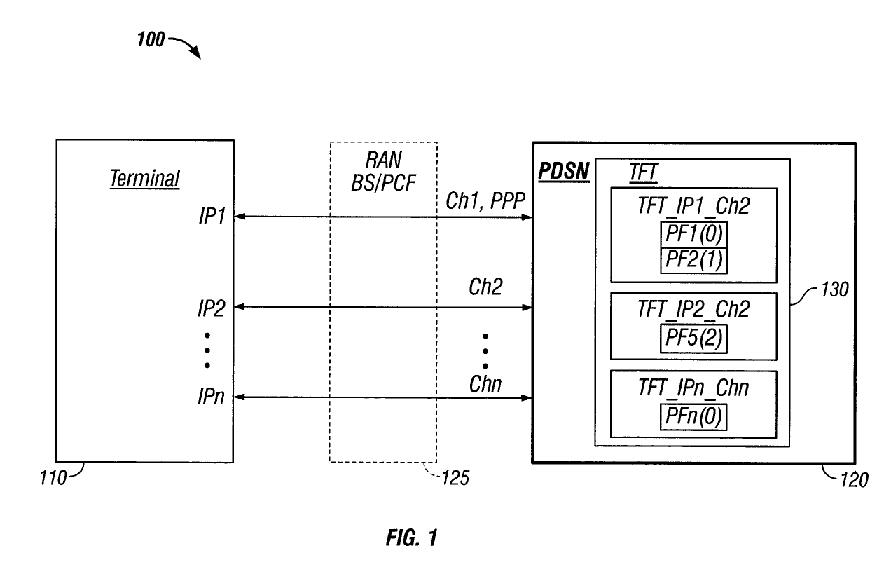

Reference is now made to FIG. 1, which is illustrating a PPP session in a telecommunication network 100 between a terminal 110 and a Packet Data Serving Node (PDSN) 120 in accordance with the present invention. The telecommunications network 100 comprises a radio access network (RAN) 125 having a base station (BS) for receiving signaling/data from the terminal 110 and a packet core function (PCF) for interacting with the PDSN 120. During the PPP session, the PDSN 120 and the terminal 110 exchange data over one or many simultaneous service instances (Ch2-Chn) for providing services (also referred herein as applications) such as Voice over IP and Multimedia to the terminal 110. The present invention is not limited to the providing of these two services, and it should be clear that any service that can be provided by the present network is also encompassed.

After establishment of the PPP session between the terminal 110 and the PDSN 120 (shown as Ch1,PPP) , a first service instance (shown as Ch2) is created for the terminal 110 and is defined as being a primary service instance . It is possible in CDMA 2000 wireless networks to establish a plurality of secondary service instances between the terminal 110 and the PDSN 120. Each service instance corresponds to at least one IP address. Each of the service instances established for the terminal 110 can be used to transfer packet data flows related to multiple services. When more than one service instance (Ch3-Chn) is created for the terminal 110, the transfer of packet flows between the terminal 110 and the PDSN 120 over the many service instances can become quite chaotic and inefficient. Therefore, the present invention provides a mechanism to define one or many traffic flow templates (TFT) 130 to coordinate the exchange of packet flows over the many service instances. Each of the TFTs is associated with one IP address, and thus to a corresponding one of the service instances established for the terminal 110.

Usually the TFT 130 is mostly used for the secondary service instances, but it is also possible with the present invention to define a TFT 130 for the primary service instance. The terminal 110, based on its knowledge of its various active service instances, applications it is currently using, and other criteria, establishes the content of the TFT 130. Then, the established content is sent transparently via the RAN 125 to the PDSN 120, and stored in the PDSN 120.

Once stored in the PDSN 120, the TFT 130 enables packet classification and policing for downlink data transfer, also referred herein as packet data flow. Thus, the TFT 130 allows the PDSN 120 to forward incoming downlink traffic for the terminal 110 to the most appropriate and efficient service instance as determined by the terminal 110 itself. For this, packet filters are matched to types of incoming downlink traffic. Also, each of the packet filters comprises a packet filter content that includes attributes, which will be described in more detail later on. The terminal 110 manages packet filter identifiers and evaluation precedence indexes based on the current service instances (Ch2-Chn) applications it is currently using, for creating packet filter contents. Of course, to use packet filters in an outmost efficient way, it is preferable that the terminal 110 uses attributes that are expected to be similar to those of incoming packet flows.

Each of the packet filters is identified by a packet filter identifier and comprises an evaluation precedence index that is unique within all TFTs that are stored in the PDSN 120 for the terminal 110. The number of stored TFTs in the PDSN 120 for the terminal is based on the terminal needs and preferences.

For example, a terminal user may determine that it prefers not having a TFT for each of the service instances (Ch2-Chn) it is currently using, or that many packet filters should be used for the various applications currently using one specific service instance.

In FIG. 1, the evaluation precedence is noted in parenthesis PFx(n), where x=packet filter number and n=evaluation precedence. An evaluation precedence index is in the range of 255 (lowest evaluation precedence) down to 0 (highest evaluation precedence). Table 1, hereinafter, shows examples of packet filter identifiers, evaluation precedence indexes, length of packet filter content and packet filter contents.

[image]

The PDSN 120 uses the evaluation precedence index to look up for a packet filter that would match the incoming packet data flow for the destination terminal 110. A description will be further provided on the determination of a match. If a match is found the packet data flow is sent over the corresponding service instance. However, if a match is not found the packet is either directed to a service instance that does not have a TFT (primary service instance) or is simply discarded. If desired, the TFT can store packet filters in the PDSN 120 in a manner similar as described in Table 1.

The TFT 130 may be associated with more that one service instance, or IP address, used by the terminal. FIG. 1 shows three TFTs for three IP addresses (IP1, IP2 and IPn) authorized for the single PPP session and associated to two service instances identified by Ch2 and Chn. The two TFTs associated to the same service instance but two distinct IP addresses may be different in content or may be the same depending on what is needed by the terminal 110.

When the terminal 110 uses Mobile IP co-located care of address, the TFT 130 is preferably identified by the co-located care of address assigned by the PDSN 120. As an example, if the terminal 110 does not have a security association with the destination to enable route optimization, it would include a Home Agent (HA) IP address as an attribute to the packet filter. When the PDSN 120 receives a source IP address and a HA IP address in the packet filter, the HA IP address would be used for mapping a router IP header. Other fields are used for mapping of the inner IP header. Therefore, packet filters are directed for many usages.

For example, based on the type of traffic or the external-network QoS capabilities, different types of packet filters can be used to classify a given packet data flow in order to determine the right service instance for transferring the packets to the terminal 110. Some other examples exist and are described as follows:

1) IPv4 Multi-field Classification

In the case of multi-field classification, the packet filter may consist of a number of packet header fields. For example, to classify TCP/IPv4 packets originating from 172.168.8.0/24 destined to port 5 003 at the TE, the following packet filter can be used:

Packet Filter Identifier=1;

IPv4 Source Address={172.168.8.0 [255.255.255.0]};

Protocol Number for TCP=6; and

Destination Port=5003.

2) IPv4 TOS-based Classification

In the case of TOS-based classification, the packet filter may consist of only the TOS octet coding. For example to classify IPv4 packets marked with TOS coding 00101 Oxx, the following packet filter can be used:

Packet Filter Identifier=3; and

Type of Service/Traffic Class=00101000 and Mask=11111100.

The TOS-based classification can always be increased with the source address attribute if it is known that different source domains use different TOS octet codings for a same traffic class.

3) IPv4 Multi-field Classification for IPSec Traffic

In the case of multi-field classification of IPSec traffic, the packet filter may contain the SPI instead of the port numbers that are not available due to encryption. If IPSec (ESP) was used with an SPI of O×OF80FOOO, then the following packet filter could be used:

Packet Filter Identifier=4;

Protocol Number for ESP=50; and

SPI=O×OF80FOOO.

It should be clear for those skilled in the art that the present invention is not limited to the examples described before, and that many other possibilities are also encompassed by the present invention. It should also be understood that FIG. 1 shows a simplified network, and that many other nodes have been omitted for clarity purposes only. Also, it should be noted that interfaces, such as an R-P interface have been omitted from FIG. 1 for clarity reasons. Of course, those skilled in the art will recognized that the R-P interface (not shown) is required between the RAN 125 and the PDSN 120 for enabling flow of data there between. Therefore, an R-P session is established over the R-P interface for the PPP session, in a manner well known in the art and included by reference herein. When the terminal changes RAN during a packet data flow, the R-P session between the previous RAN 125 and the PDSN 120 is released and a new R-P session is established between a new RAN and the same PDSN 120 or a new PDSN. It should also be clear for those skilled in the art that packet filters that can be used for RSVP protocol or 3 GPP are different from those used in cdma2000 network , since cdma2000 uses Mobile IP and possibly IP encapsulation.

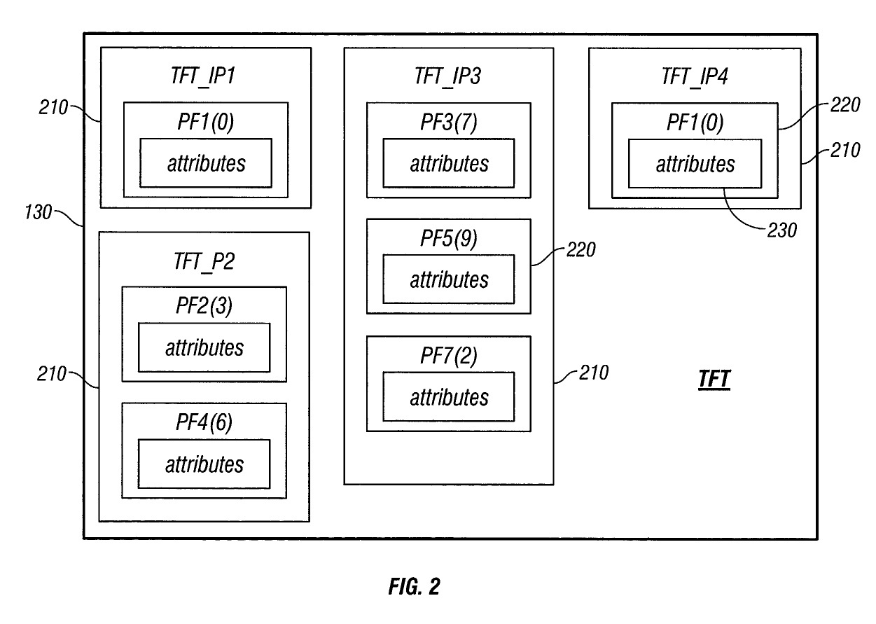

Reference is now made to FIG. 2, which illustrates a traffic flow template (TFT) 200 for storing packet filters and packet filter contents in accordance with the present invention. The TFT 200 comprises TFT options 210 associated to a single IP address. Each one of the TFTs 210 comprises at least one of the valid packet filters 220 and each of the valid packet filters 220 contains a unique packet filter identifier within the TFT 130. Also each valid packet filter 220 contains an evaluation precedence index that is unique within all TFT options 210 associated to a single IP address. Packet filters 220 also comprise at least one of the attributes 230 for defining packet filter contents.

Some examples of attributes are listed and described as follows:

1) Source Address and Subnet Mask: The Source Address and Subnet Mask attribute shall contain an IPv4 or IPv6 address along with a subnet mask. As an example, the source address and subnet mask attribute to classify packets coming from all hosts within the IPv4 domain A.B.C.0/24 is {A.B.C.O [255.255.255.0]};

2) Protocol Number/Next Header: The Protocol Number/Next Header attribute shall contain either an IPv4 Protocol Number or an IPv6 Next Header value. The value range is from 0 to 255;

3) Port Numbers (Destination Port Range and Source Port Range):

The Destination Port Range and Source Port Range attributes shall each contain one port number, or a range of port numbers. Port numbers range between 0 and 65535;

4) IPSec Security Parameter Index (SPI): The IPSec SPI attribute shall contain one SPI, which is a 32-bit field;

5) Type of Service/Traffic Class and Mask: The Type of Service/Traffic Class and Mask attribute shall contain either an I Pv4 TOS octet or an I Pv6 Traffic Class octet along with a mask defining which of the 8 bits should be used for matching;

6) Flow Label: The Flow Label attribute shall contain an IPv6 flow label which is a 20-bit field; or

7) Home Agent IP address: The Home Agent IP address and subnet mask attribute shall contain an IPV4 or IPV6 address along with a subnet mask. It will be used when mapping an outer IP header. This attribute will only be used for terminal using Mobile IP access with co-located care of address.

The present invention is not limited to those examples of attributes, and many other attributes could also be used. It is also important to understand that some of the above-listed attributes may coexist in a packet filter while others mutually exclude each other. In Table 2 below, a preferred possible combination is shown.

TABLE 2
Preferred Packet filter attributes combination

| | Valid combination types | | | |
|---|---|---|---|---|
| Packet filter attribute | I | II | III | IV |
| Source address and Subnet Mask | X | X | X | X |
| Protocol number (IPv4)/Next header (IPv6) | X | X | | X |
| Destination Port Range | X | | | X |
| Source Port Range | X | | | X |
| IPSec SPI | | X | | |
| TOS (IPv4)/Traffic Class (IPv6) and Mask | X | X | X | X |
| Flow Label (IPv6) | | | X | |

Only those attributes marked with an “X” may be specified for a single packet filter. All marked attributes may be specified, but at least one shall be specified. If the parameters of the header of a received packet match all specified attribute values in a packet filter, then it is considered that a match is found for this packet filter. In this case, the evaluation procedure is aborted. Other packet filters in increasing order of their evaluation precedence index are evaluated until such match is found. There may be potential conflicts if attribute values are combined in such a way that the defined filter can never achieve a match to a valid IP packet header. If a match cannot be found, the PDSN 120 maps the packet to the primary service instance.

If more than one IP address is associated to a single PPP session such as in FIGS. 1 and 2, a TFT would be uniquely associated with each of the authorized IP addresses. The TFTs would be uniquely identified by the authorized IP addresses used by the terminal. Consequently, multiple TFTs for each IP addresses could be associated with a single service instance. In FIG. 2, the TFTs 210 consists of from one and up to N packet filters, each identified by a unique packet filter identifier.

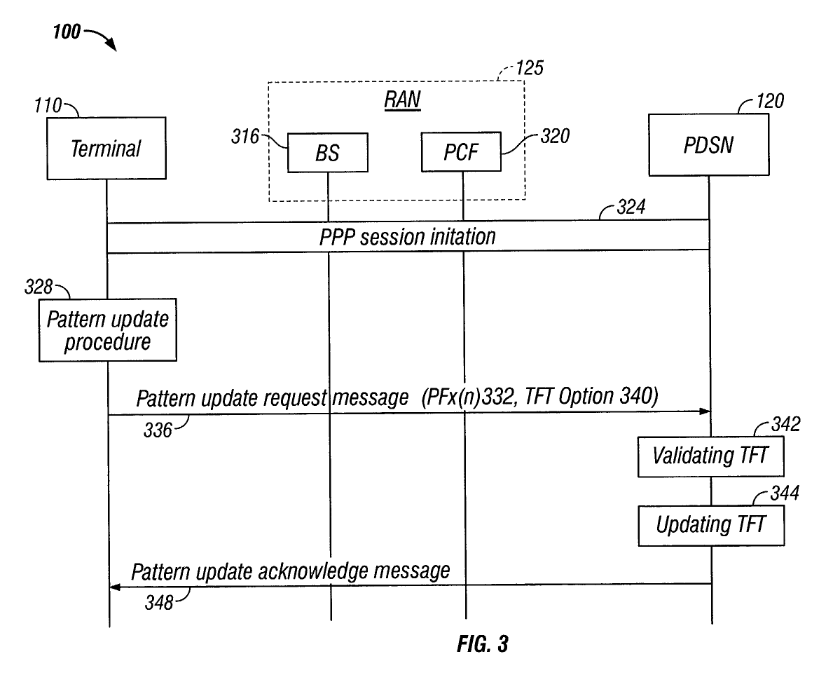

A TFT can be added by the terminal 110 using a Pattern update procedure. More particularly, the Pattern update procedure modifies or removes any TFTs in the PDSN 120. The Pattern update procedure is described in FIG. 3.

Reference is now made to FIG. 3, which illustrates a message flow diagram for managing incoming packet flows in a telecommunications network 100. The telecommunications network 100 comprises a radio access network (RAN) 125 for transparently sending information between the PDSN 120 and the terminal 110 during a PPP session. The RAN 125 comprises a BS 316 for receiving signaling from the terminal 10 and a PCF 320 for interacting with the PDSN 120. Before any exchange of data between the PDSN 120 and the terminal 110, a PPP session is established following the PPP session initiation 324. Next, when the terminal 10 creates a new TFT, modifies an existing TFT or deletes a stored TFT in the PDSN 120, it uses a Pattern update procedure 328. In the pattern update procedure, the terminal 110 has to include at least one valid packet filter identifier (PFx(n) 332). Another way for deleting a TFT may be when a corresponding service instance is disconnected. If no valid packet filter is included in the newly created or modified TFT, the procedure used for the creation or modification of the TFT shall fail, and an error code shall be returned to the terminal 110. During a modification of a TFT, one or more existing packet filters can be modified or deleted, or a new packet filter can be created. In order to modify an existing packet filter, new values for the packet filter attributes along with the packet filter identifier are sent from the terminal 110 to the PDSN 120. The terminal 110 may also modify an evaluation precedence index only of one or several packet filters by means of the Pattern update procedure 328. Following the Pattern update procedure 328, the terminal 110 generates a message code in a Pattern update request message 336 including the new PFx(n) 332.

In addition, the Pattern update request message 336 may include one or more TFT options (TFT option 340). Table 3 gives examples of TFT options and a position for different possible parameters related to a TFT option.

[image]

The TFT option 340 is uniquely identified by an authorized IP address used by the terminal 110. More than one TFT options associated with different IP addresses are allowed in a single message if multiple authorized IP addresses are associated with the single PPP session. Afterwards, the Pattern update request message 336 is further sent to the PDSN 120. The PDSN 120 receives Pattern update request message 336 and validates the TFT 340 at step 342 and updates the TFT 340 using the PFx(n) 332, at step 344. Following this, the PDSN 120 sends an acknowledgment back to the terminal 110 in the event of successful configuration in a Pattern update acknowledge message 348. However, if the terminal 110 cannot validate or configure the requested TFTs, a reject indicating unsuccessful establishment of the TFT will be sent back to the terminal. If multiple TFTs were included in the Pattern update request message 336, and the PDSN 120 failed in configuring one of the TFTs, a negative acknowledgment will be sent back to the terminal 110 including the unsuccessful non-processed TFT in a Pattern update reject message (not shown).

The mechanism defined in the invention is extremely flexible and extendible, and 3 GPP networks and networks using RSVP will benefit from using the traffic flow template mechanism described in the invention.

Although several preferred embodiments of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A traffic flow template for indicating preferred treatment of a service instance, the table comprising:
at least one packet filter, each of the at least one packet filter including packet filter attributes and an associated packet filter identifier; and
an IP address associated with the packet filter.

2. The traffic flow template of claim 1, the table further comprising an evaluation precedence index.

3. The traffic flow template of claim 1, wherein the table is stored in a Packet Data Serving Node.

4. The traffic flow template for indicating preferred treatment of claim 1, wherein each of the at least one packet filter including packet filter attributes is managed by a terminal.

5. The traffic flow template of claim 1, wherein the table is updated by means of a pattern update message sent from a terminal to a Packet Data Serving Node.

6. A terminal for managing packet filters, the terminal being capable of:
managing packet filter identifiers;
managing evaluation precedence indexes of the packet filters;
creating a packet filter content, the packet filter content including packet filter attributes and an associated packet filter identifier; and
associating packet filter to a current IP address of the terminal.

7. The terminal for managing packet filters of claim 6, further being capable of:
performing a pattern update procedure prior to generating a pattern update message including at least one packet filter identifier; and
sending the pattern update message to the packet data serving node.

8. The terminal for managing packet filters of claim 6, further being capable of:
receiving a pattern update acknowledge message from a packet data serving node.

9. A packet data serving node (PDSN) for storing at least one traffic flow template associated to a service instance, the PDSN being capable of:
receiving a pattern update request message from a terminal, the pattern update request message including at least a packet filter identifier; and
using an evaluation precedence index to look up for a packet filter match.

10. The PDSN of claim 9 for storing the at least one traffic flow template, further being capable of:
validating the traffic flow template;
updating the traffic flow template generating a pattern update acknowledge message; and
sending the pattern update acknowledge message to the terminal.

11. The PDSN of claim 9 for storing the at least one traffic flow template, further being capable of:
forwarding to the terminal an incoming downlink traffic to a corresponding service instance.
